(19) United States
(12) Patent Application Publication
(10) Pub. No.: US 2011/0305809 A1
(43) Pub. Date: Dec. 15, 2011

(54) METHOD AND SYSTEM FOR EXTRUDING A CONSUMABLE END FRUIT PRODUCT

(76) Inventors: John Alan Madsen, Kelowna (CA); Cherry Elizabeth Nicholson, Kelowna (CA)

(21) Appl. No.: 13/054,775

(22) PCT Filed: Jul. 17, 2009
(86) PCT No.: PCT/CA09/01016

§ 371 Date: Aug. 30, 2011

Related U.S. Application Data
(60) Provisional application No. 61/081,992, filed on Jul. 18, 2008.

(51) Int. Cl. A23L 1/212; A23P 1/12; B29C 47/78

(52) U.S. Cl. 426/465; 425/378.1; 426/516

(57) ABSTRACT

Described are a method and system for producing a consumable end fruit product composed of about 100% fruit from an intermediate fruit product having a sugar content of about 84 to 88° Brix. The intermediate fruit product, which is heated to a temperature of at least about 90° C. prior to extrusion, is extruded to form an extruded fruit product; which is cooled to about 20° C. to form the consumable end fruit product. One example of the system includes an extruder to extrude the intermediate fruit product into an extruded fruit product; a conveyor to receive the extruded fruit product from the extruder; a cooling portion having a first cooling unit; a drying portion having a drying tunnel; and a second cooling unit. The extruded fruit product moves from the first cooling portion to the drying portion and then to the second cooling portion.

### FIELD OF THE INVENTION

The present invention relates to a method and system for extruding a consumable end fruit product from a viscous intermediate fruit product, wherein the consumable end fruit product contains a high proportion of fruit.

### BACKGROUND OF THE INVENTION

Increasingly, consumers are concerned about eating healthily. Generally, consumers associate eating healthily with consuming fruit snacks that contain a high proportion of fruit. Such fruit snacks are often perceived as being healthier than fruit snacks that contain additives such as processed or refined sugars, starches, gelatins, gums and preservatives. An example of a fruit snack containing a high proportion of fruit is Sun-Rype™ Products Ltd.'s (“Sun Rype's”) Squiggles™ fruit snack.

In order to produce a consumable end product containing a high proportion of fruit (i.e., the fruit snack), raw materials forming a precursor fruit product can first be transformed into an intermediate product having appropriate properties for forming into the end product. In particular, it is helpful if the intermediate product has certain physical properties, such as sufficient viscosity, that make it suitable for extrusion into the end product. There are a number of challenges in forming the end product from the intermediate product, some of which include:
conveying extruded intermediate product through a processing line, which is challenging because the extruded product is very sticky as a result of it being composed of a high proportion of fruit. The stickiness of the extruded product results in the intermediate product tending to stick to components of the processing line and to neighbouring ropes or strips of extruded intermediate product; and
drying or cooling the intermediate product into the end product should be done so as not to render the end product's texture or flavour unsuitable for consumption.

These problems are alleviated when the precursor fruit product is not composed of a high proportion of fruit, as the additives typically found in such precursor fruit products, such as gelatins, starches, and refined sugars, can be used to create an intermediate product with a high Brix content at lower cooking temperatures, and which are not as sticky or viscous as an intermediate product containing a high proportion of fruit.

Consequently, there is a need for a method and system for forming a consumable end fruit product having a high proportion of fruit from a viscous intermediate fruit product.

### SUMMARY OF THE INVENTION

Accordingly, it is an object of the invention to provide at least one of a method or system for forming a consumable end fruit product.

According to a first aspect of the invention, there is provided a method for producing a consumable end fruit product composed of a high proportion of fruit from an intermediate fruit product. By “high proportion of fruit”, it is meant that the consumable end fruit product can have between about 50% to about 100% fruit material; alternatively about 60% to about 100% fruit material; alternatively about 70% to about 100% fruit material; alternatively about 80% to about 100% fruit material; alternatively about 90% to about 100% fruit material; or alternatively about 100% fruit material. In this application, “fruit” or “fruit material” includes any material derivable from fruit, including isolated pectin, but excludes non-fruit materials such as refined sugars, starches, and oils.

The method includes the steps of extruding the intermediate fruit product to form an extruded fruit product; and cooling the extruded fruit product to form the consumable end fruit product. The step of extruding the intermediate fruit product can be performed at a temperature of at least about 90° C. The step of cooling the extruded fruit product can include cooling the extruded fruit product to about 20° C. The intermediate fruit product can include a fruit product having a sugar content of about 84 to about 88° Brix.

The step of extruding the intermediate fruit product to form the extruded fruit product can include the additional steps of extruding the intermediate fruit product on to a conveyor belt at an extrusion rate, the extruded fruit product contacting the conveyor belt; and conveying the extruded fruit product away on the conveyor belt at a belt rate. The ratio of the extrusion rate over the belt rate can be about 3.7 kg/m, where the extrusion rate is about 10 kg/min and the belt rate is about 2.7 m/min. The ratio of the extrusion rate over the belt rate can be at least about 4.0 kg/m, whereby increasing the ratio results in the extruded fruit product taking on an undulating shape. The extruded fruit product can take on an undulating shape when the extrusion rate is about 8.3 kg/min and the belt rate is about 2.1 m/min, for example.

The step of cooling the extruded fruit product to form the consumable end fruit product can include the steps of cooling the extruded fruit product a first time; drying the extruded fruit product; and then cooling the extruded fruit product a second time. The step of cooling the extruded fruit product a first time can include cooling the extruded fruit product to about 30° C. The step of drying the extruded fruit product can include heating the extruded fruit product within a drying tunnel that is at a temperature of about 95° C. for about 20 minutes. The step of cooling the extruded fruit product a second time can include cooling the extruded fruit product to about 18° C.

The method for producing a consumable end fruit product can also include the step of cutting the consumable end fruit product with a guillotine. The guillotine can cut the consumable end fruit product to any suitable length.

According to a further aspect of the invention, there is provided a system for producing a consumable end fruit product composed of a high proportion of fruit from an intermediate fruit product. The system includes an extruder, the extruder extruding the intermediate fruit product into an extruded fruit product; a conveyor, the conveyor receiving the extruded fruit product; and a cooling portion, the conveyor transporting the extruded fruit product into the cooling portion, the cooling portion outputting the consumable end fruit product. The consumable end fruit product can be composed of about 100% fruit. The cooling portion can include a first cooling unit.

In addition to having a first cooling portion, the system may also include a drying portion and a second cooling portion, the extruded fruit product being conveyed from the first cooling portion to the drying portion and then to the second cooling portion, the second cooling portion outputting the consumable end fruit product. The drying portion may include a drying tunnel and the second cooling portion may include a second cooling unit.

The extruder can include a manifold; a pump fluidly coupled to the manifold; and a nozzle fluidly coupled to the pump, the nozzle extruding the intermediate fruit product into the extruded fruit product. Steam may be circulated around or through any one or more of the manifold, pump, and nozzle. The nozzle can be positioned substantially parallel to and behind a topmost surface of the conveyor belt, or can be positioned above the conveyor belt. When positioned above the conveyor belt, the nozzle can be positioned at an angle of about 60 degrees relative to the conveyor belt, and a semi-cylindrical bump can be positioned underneath the nozzle for receiving the extruded fruit product. The nozzle can further include a mask for defining a cross section of the extruded fruit product. The mask can have a pattern selected from the group consisting of a rocket ship, a crescent moon, a star, a space ship, a planet, a whale, a sea horse, an octopus, a turtle, or a sea shell, and can also have a pattern such that the extruded fruit product is in the form of a rectangular strip. If a star-shaped mask is used, the mask can further have a crenated star-shaped cross-section.

The system may also include a guillotine, the guillotine receiving the consumable end fruit product and used for cutting the consumable end fruit product.

### BRIEF DESCRIPTION OF THE DRAWINGS

In the accompanying drawings, which illustrate an exemplary embodiment of the present invention:

FIG. 1 is a top plan view of a processing line used to form a consumable end fruit product from an intermediate fruit product, according to one embodiment of the invention.

FIG. 2 is a side elevation view of the processing line as depicted in FIG. 1.

FIG. 3 is a side elevation view of a series of extrusion nozzles coupled to a nozzle bar that can be used to extrude intermediate fruit product on to the processing line as depicted in FIG. 1.

FIG. 3(a) is a side elevation view of a series of extrusion nozzles coupled to a nozzle bar that can be used to extrude intermediate fruit product on to a processing line according to an alternative embodiment, wherein the conveyor belt used in the processing line has a “speed bump” on to which fruit product can be extruded.

FIG. 4(a) is a front elevation view of a portion of a manifold coupled to pumps and the nozzle bar.

FIG. 4(b) is a side elevation view of one of the extrusion nozzles as depicted in FIG. 3 and a ball valve, which can be inserted into the nozzle bar.

FIG. 4(c) is an end view of one of the pumps used in FIG. 4(a) having a pump steam conduit, which is used to circulate steam within the pump for heating purposes.

FIG. 4(d) is a schematic, side sectional view of the pump depicted in FIG. 4(c).

FIG. 4(e) is a schematic, front sectional view of the manifold depicted in FIG. 4(a) having a manifold steam conduit, which is used to circulate steam within the manifold for heating purposes.

FIG. 5 is a cross-section of a star-shaped mask that can be placed on an end of an extrusion nozzle as depicted in FIG. 3, the mask resulting in extrusion of a rope of intermediate fruit product having a star-shaped cross-section.

FIGS. 6(a)-6(n) are cross-sections of patterns that can be placed on an end of an extrusion nozzle as depicted in FIG. 3, each pattern resulting in extrusion of a rope having a cross-section substantially similar to the pattern.

FIG. 7 is a top plan view of a processing line used to form a consumable end fruit product from an intermediate fruit product, according to a further embodiment of the invention.

FIG. 8 is a perspective view of an exemplary undulating product having a crenated cross-section that can be produced using the processing line.

FIG. 9 is a flow chart depicting steps of exemplary methods for extruding consumable end fruit product.

### DETAILED DESCRIPTION OF AN EXEMPLARY EMBODIMENT

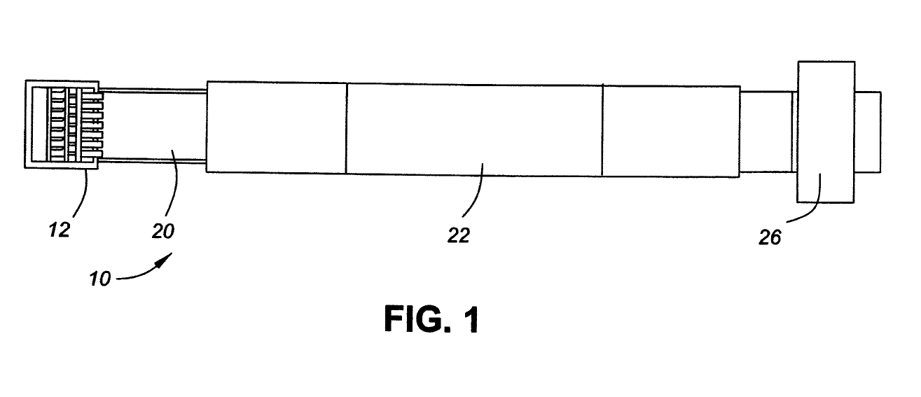

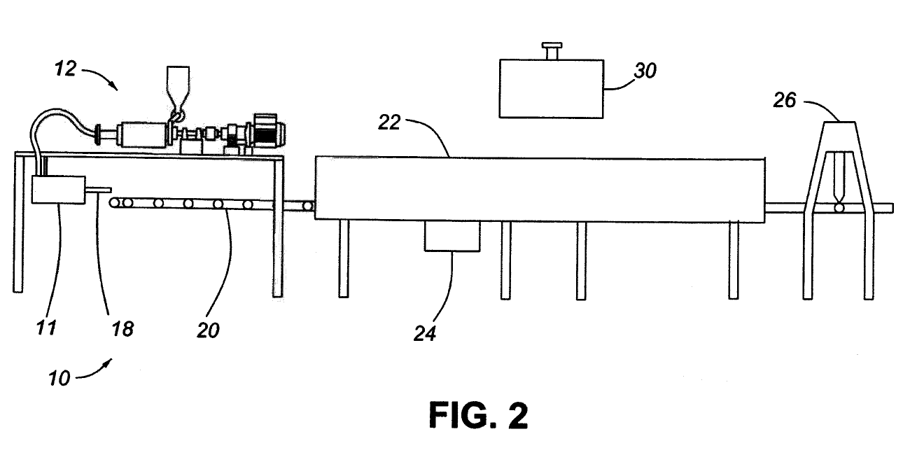

Referring generally to FIGS. 1 and 2, there is depicted a first embodiment of a processing line 10 that accepts an intermediate fruit product having 100% fruit and that outputs a consumable end fruit product. The intermediate fruit product may have a Brix level of 84-88° Brix.

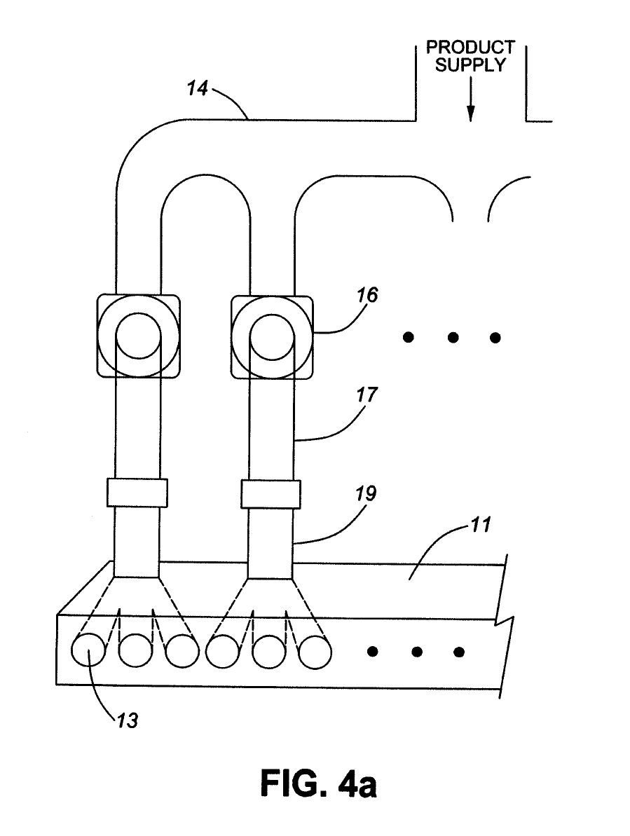

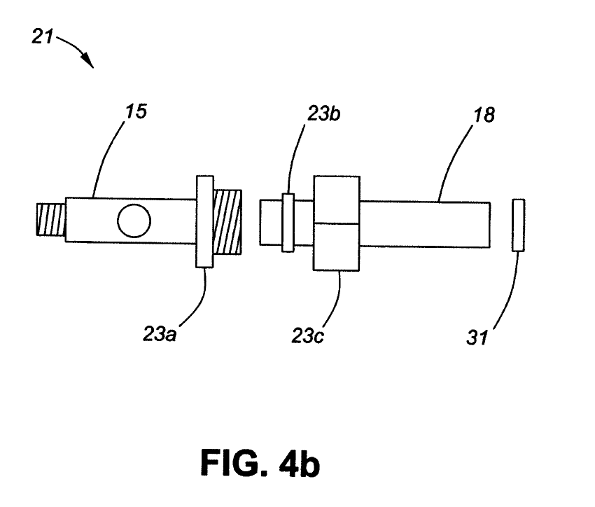

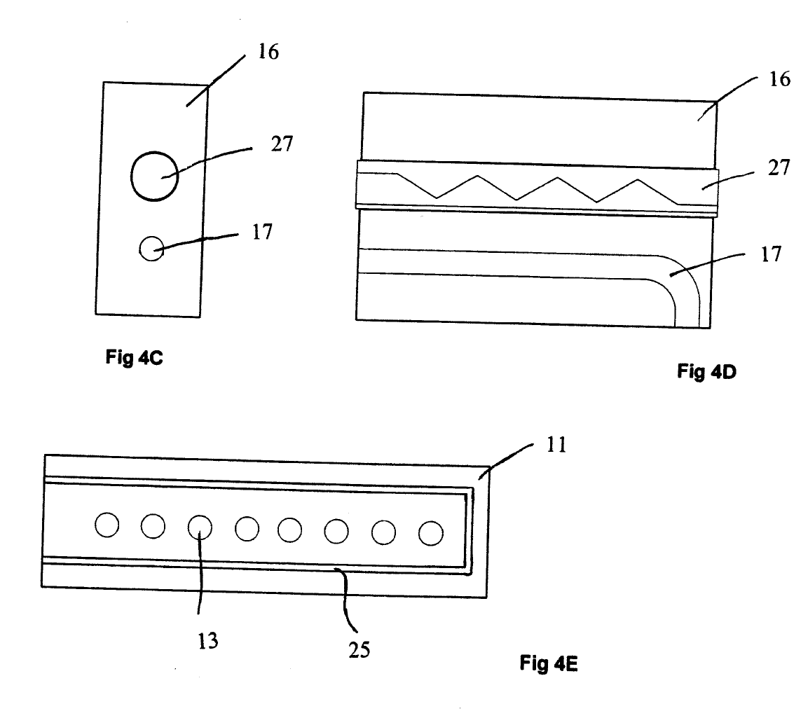

Any method known in the art can be used to create a suitable intermediate fruit product. For example, the “fruit mass” that can be produced according to the method and apparatus described in published United States patent application 2009/0169694 can act as the intermediate fruit product. The intermediate fruit product is channeled into a manifold 14 (as depicted in FIG. 4(a)) that is coupled to an extruder 12. During operation, the pressure at the manifold 14 as a result of the intermediate fruit product is about 3-4 Bar. The extruder 12 can be used, for example, to extrude the intermediate fruit product into “ropes” of various cross-sections or can be used to extrude the intermediate fruit product into substantially flat strips. By “rope”, it is meant an extruded fruit product that is not a strip. Hereinafter, all product extruded from the extruder 12, including both the ropes and strips are referred to as “extruded fruit product”. The extruded fruit product is extruded on to a conveyor belt 20, which can be a silicon-based conveyor belt so as to reduce the tendency of the extruded fruit product to stick to the belt 20. Such functionality is especially useful at the end of the processing line when the end fruit product is to be removed from the belt 20.

The extruded fruit product is conveyed to a cooling tunnel 22. The cooling tunnel 22 can use both convection cooling (between the extruded fruit product and the circulating air) and contact cooling (between the conveyor belt 20 and an underlying cooling plate) to reduce the temperature of the extruded fruit product to approximately 16-18° C. In this exemplary embodiment, with respect to convection cooling, air temperature of the cooling tunnel 22 can be set to 8° C., while the temperature of the cooling plate can be set to 8° C. The residence time of the extruded fruit product in the cooling tunnel is approximately 8 minutes. Operating in conjunction with the cooling tunnel 22 is an air dehumidifier 24 and a chiller 30. The dehumidifier 24 dehumidifies air in the cooling tunnel 22 and consequently helps to cool the extruded fruit product. The chiller 30 is used to cool the air circulating within the cooling tunnel 22 and to cool the cooling plate responsible for contact cooling.

Following cooling, consumable end fruit product results. The end fruit product can then be conveyed to a guillotine 26 for cutting. Following the guillotine 26, the consumable end fruit product is ready for packaging and consumption.

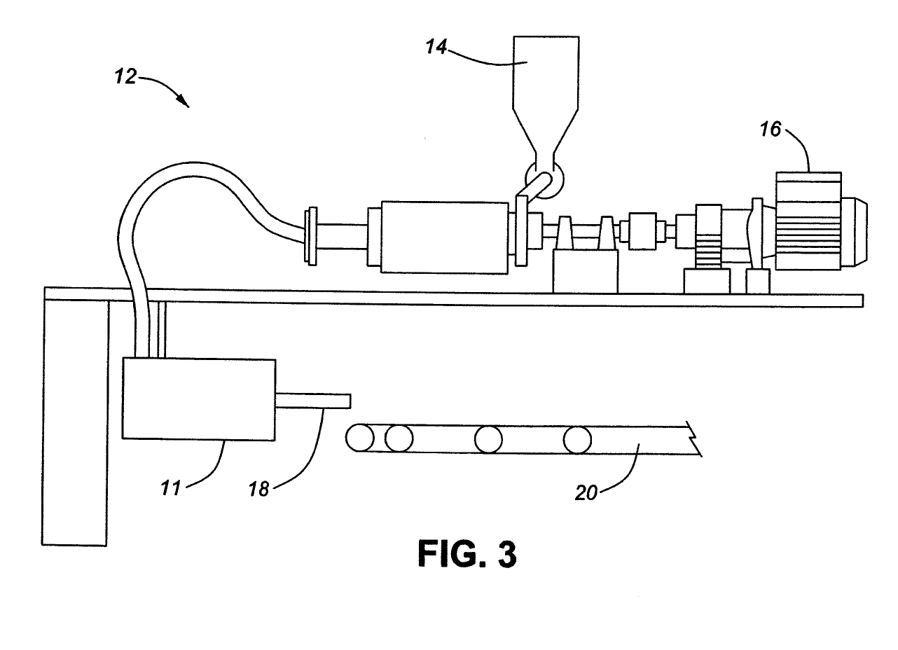

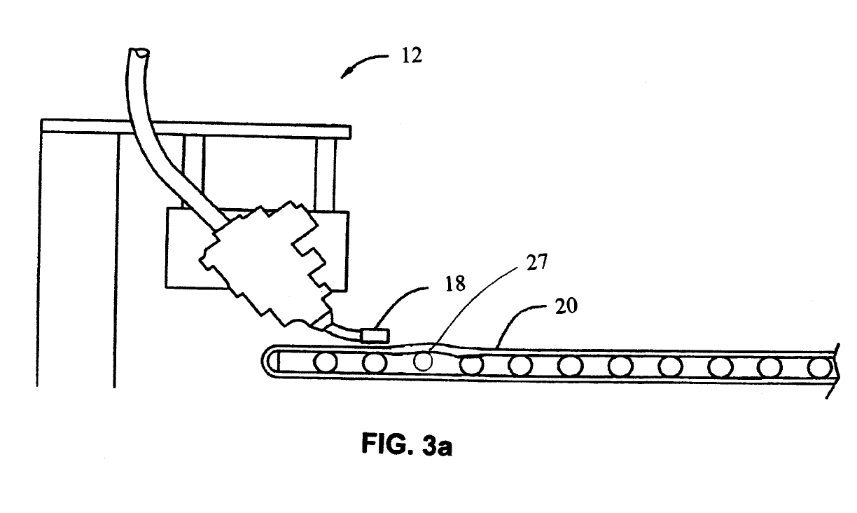

Referring now to FIGS. 3, 4(a) and 4(b), an exemplary extruder 12 is depicted. The extruder 12 has a manifold 14 that is fluidly coupled to seven positive displacement pumps 16 (only two of which are depicted in FIG. 4(a)). The positive displacement pumps 16 may be, for example, Moyno™ pumps. In this exemplary embodiment, the Moyno™ pumps form part of the extruder 12. The pumping rate of each pump is controlled by individual, adjustable frequency drives. Each pump 16 is coupled to a nozzle bar 11 via a hose 17 and hose connector 19. The nozzle bar 11 has ball valve ports 13, into which a nozzle assembly 21 can be screwed. As shown in FIG. 4(b), the nozzle assembly 21 is composed of the nozzle 18 and a ball valve 15. The ball valve 15 can be threaded, as it is in FIG. 4(b), and when threaded can be securely screwed into the nozzle bar 11. The ball valve 15 is adjustable so as to control the flow of intermediate fruit product to the nozzle 18. The ball valve 15 and the nozzle 18 can be coupled via a compression assembly, as they are in FIG. 4(b), composed of a compression fitting 23(a), compression ferrule 23(b), and compression nut 23(c). Each pump 16 pumps intermediate fruit product through three or four nozzles 18, via the nozzle bar 11, on to the conveyor belt 20. In this fashion, a total of 21 to 28 strips or ropes can be simultaneously extruded.

In order to prevent the intermediate fruit product from cooling to a temperature that renders the intermediate fruit product too viscous to extrude, the manifold 14, pumps 16, and nozzle bar 11 all should be kept above a certain temperature. In this exemplary embodiment, the temperature of the intermediate fruit product should be kept above 90° C. prior to and during extrusion. This can be done by circulating steam through pipes surrounding or embedded within the manifold 14, pumps 16, and nozzle bar 11, for example.

For instance, FIGS. 4(c) and 4(d) are end and sectional views, respectively, of one of the pumps 16 that includes a pump steam conduit 17 for circulating steam and for maintaining the temperature of the intermediate fruit product at a temperature that is suitable for extrusion. The pump 16 has a pump body through which extends a product conduit 27. The intermediate fruit product is pumped through the product conduit 27 and, subsequently, to the nozzle bar 11. The pump steam conduit 17 also extends through the pump body. In FIGS. 4(c) and 4(d), the pump steam conduit 17 enters the pump body through the rear side of the pump 16, extends parallel to the product conduit 27 for substantially the entire length of the pump body, and exits the pump body through the bottom side of the pump 16. Although in FIGS. 4(c) and 4(d) the pump steam conduit 17 enters the pump 16 through its rear side and exits through its bottom side, in alternative embodiments (not shown) the pump steam conduit 17 can have any number of shapes. For example, the pump steam conduit 17 may extend parallel to the product conduit 27 for the entire length of the pump 16, thereby exiting the pump 16 through its front side; may have a spiral shape that encircles the product conduit 27; and may enter and exit the pump 16 via any of the sides of the pump 16.

FIG. 4(e), which is a sectional view of the nozzle bar 11, illustrates how a nozzle steam conduit 25 can extend through the body of the nozzle bar 11 in order to maintain the temperature of the intermediate viscous fruit product at a level that is suitable for extrusion. In FIG. 4(e), the nozzle steam conduit 25 is “U”-shaped and enters and exits the nozzle bar 11 through one side of the nozzle bar 11. The ball valve ports 13 are thereby simultaneously heated from three sides by the nozzle steam conduit 25. As with the pump steam conduit 17, in alternative embodiments (not shown), the nozzle steam conduit 25 can have any number of shapes. For example, the nozzle steam conduit 25 can extend in between adjacent pairs of ball valve ports 13, or two nozzle steam conduits 25 can extend in parallel within the body of the nozzle bar 11 and parallel to the top and bottom surfaces of the nozzle bar 11.

Steam can be circulated through the manifold 14, pumps 16, and nozzle bar 11 in series such that only the temperature of the last pump 16 in series and nozzle bar 11 need be monitored in order to ensure that the temperature of all pumps 16 and nozzle bar 11 are above 90° C.

The nozzles 18 can be positioned relative to the conveyor 20 in several ways. In the exemplary embodiment depicted in FIG. 3, the nozzles 18 are positioned substantially horizontal to and slightly behind the conveyor belt 20. In an alternative embodiment depicted in FIG. 3(a), the nozzles 18 can be positioned directly over the conveyor belt 20. When so positioned, the nozzles 18 may be positioned at an angle relative to the conveyor belt 20; locating the nozzles 18 at an angle of 60° relative to the conveyor belt 20 has been found to be particularly beneficial. Furthermore, in this alternative embodiment, a small lump, or “speed bump” 27, that extends underneath and transverse to the direction of motion of the conveyor belt 20 can be positioned forward of the nozzles 18 to aid in forming the shape of the extruded fruit product. The speed bump 27 can be semi-cylindrical or elliptical (i.e.: have a semi-circular or elliptical cross-section), be positioned approximately at the position the extruded fruit product contacts the conveyor belt 20, and be about 60 mm long and about 30 mm high. The “length” of the speed bump 27 refers to distance the speed bump 27 extends in a direction parallel to the direction of motion of the conveyor belt 20, while the “height” of the speed bump 27 refers to the distance the speed bump 27 displaces the conveyor belt 20 in a direction normal to the surface of the conveyor belt 20.

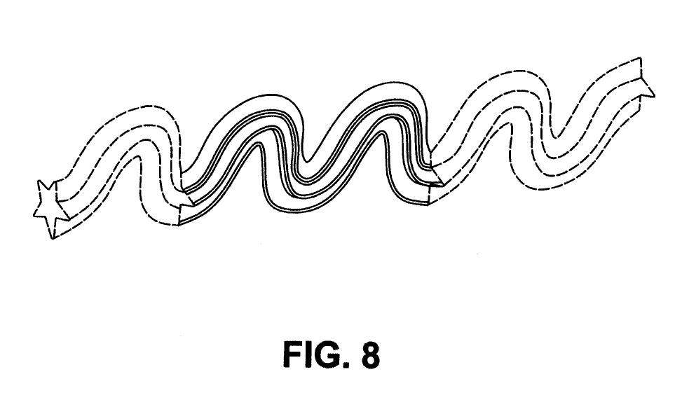

The rates at which the intermediate fruit product is extruded (the “extrusion rate”) and the rate at which the conveyor belt 20 moves (the “belt rate”) will depend on the nature of end fruit product desired. At certain relative extrusion and belt rates, the extruded fruit product will be substantially linear. In an exemplary embodiment wherein a total of 28 extrusion nozzles 18 are used, a cumulative extrusion rate of 640 kg/hr and a belt rate of 2.7 m/min result in a substantially linear rope or strip of extruded fruit product. Subsequently increasing the extrusion rate while keeping the belt rate the same will result in an undulating extruded fruit product. Similarly, subsequently decreasing the belt rate while keeping the extrusion rate the same will also result in an undulating extruded fruit product. An exemplary undulating extruded fruit product is depicted in FIG. 8. In order to obtain this exemplary undulating extruded fruit product, the cumulative extrusion rate can be set to 530 kg/hr and the belt rate can be set to 2.1 m/min.

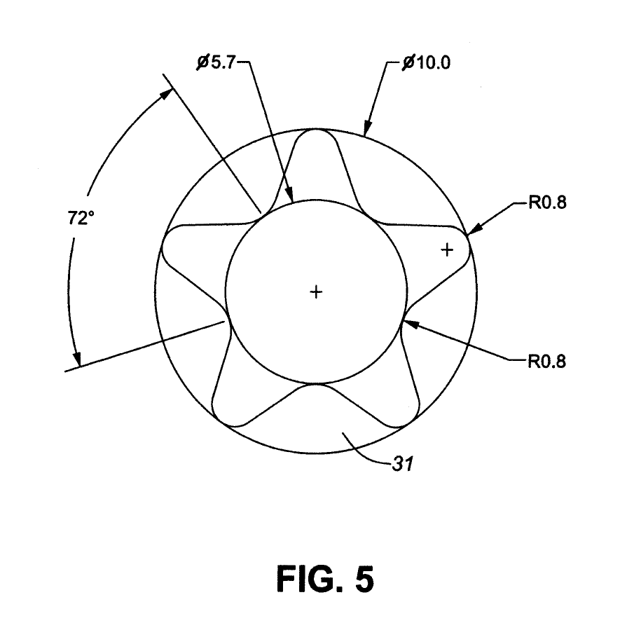

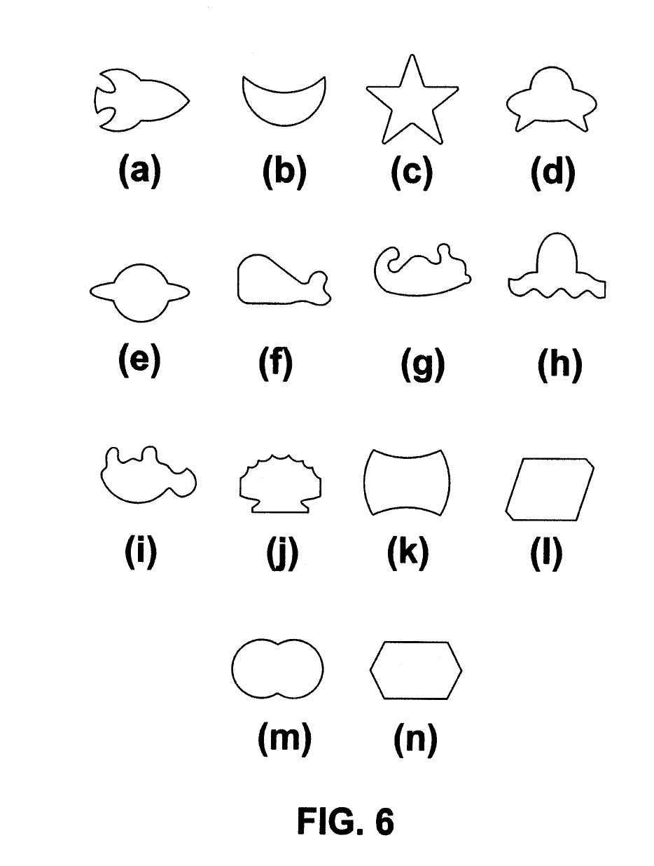

Referring now to FIGS. 4(b) and 5, there is shown an exemplary mask 31 that can be fitted on to an end of any of the nozzles 18 such that the extruded fruit product has a star-shaped cross-section. Referring now to FIGS. 6(a)-6(n), there are depicted other exemplary shapes that can be formed into masks to result in the extrusion of a rope of extruded fruit product having the depicted cross-section. FIGS. 6(a)-6(j) are, respectively, a rocket ship; a crescent moon; a star; a space ship; a planet; a whale; a sea horse; an octopus; a turtle; and a sea shell. Notably, shapes such as the sea horse and the turtle are extruded on to their backs so as not to distort the delicate features of the shapes against the conveyor belt 20. FIGS. 6(k)-6(n) are various geometric shapes.

While the above text describes the operation of one embodiment of the processing line 10 in steady-state, prior to entering steady-state operation certain start-up steps that transition the processing line 10 from a non-operational state to steady-state should be followed. These steps include:
1. Pre-heat the manifold 14, pumps 16 and nozzle bar 11 to at least about 90° C. using steam, for example.
2. Activate all the elements of the processing line 10 (i.e.: from the conveyor belt 20 to the guillotine 26) except for the extruder 12 such that they operate as they do in steady-state.
3. Open all nozzles 18.
4. Ensure that the manifold 14 of the extruder 12 is sufficiently hot to begin the extrusion process. The manifold 14 should be “too hot to touch”. For example, in embodiments wherein the manifold 14 is heated using steam, as described above, the manifold can be around 90° C.
5. Set the pumps 16 to extrude at a rate of about 740 kg/hour.
6. Feed the intermediate fruit product into the manifold 14 such that the pressure at the manifold is about 2 Bar. At about 2 Bar pressure, the pumps 16 can begin pumping.
7. While product is being extruded from the nozzles 18, adjust the nozzles 18 until they are roughly parallel with an end of the conveyor belt 20.
8. Adjust rate of pumps 16 until extruded ropes are of the desired thickness. Rope thickness can be increased by increasing the pumping rate of the pumps 16, and can be decreased by decreasing the pumping rate of the pumps 16. Following this, any components of the processing line 10 not yet operating in steady-state can be transitioned to steady-state.
9. After about 30-35 minutes, the heating of the manifold 14, pumps 16 and nozzle bar 11 referenced in step 1 can end.

### Alternative Embodiment

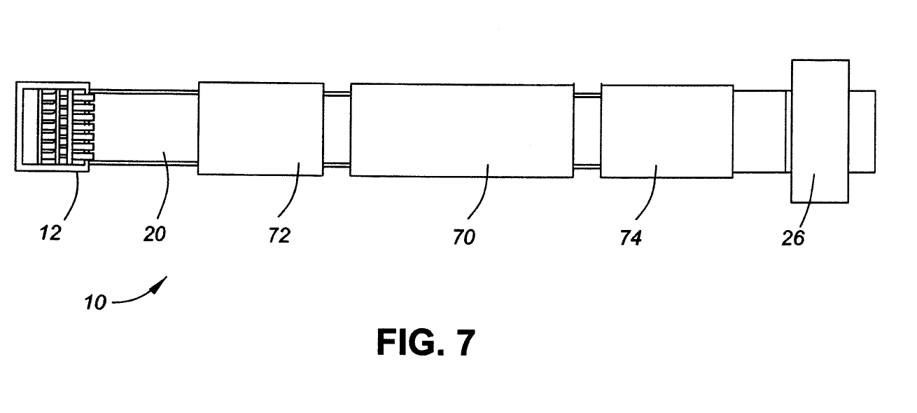

In an alternative embodiment of the processing line 10 as depicted in FIG. 7, the processing line 10 may have a drying tunnel 70 interposed between two cooling units 72, 74. The drying tunnel 70 can be used when the intermediate fruit product being extruded has a higher moisture content than the intermediate fruit product used in the embodiment of the processing line 10 without a drying tunnel 70. Intermediate fruit product having a Brix level of 84-86° Brix can be extruded with this alternative embodiment. The drying tunnel 70 is set such that its air temperature can be 95° C., and the residence time of the extruded fruit product within the drying tunnel 70 is approximately 20 minutes. The air temperature of the cooling unit 72 and the temperature of the cooling plate can be set to about 10° C. The residence time of the extruded fruit product within the cooling unit 72 is approximately 4 min. The temperature of the extruded fruit product upon exiting the cooling unit 72 is about 30° C. The air temperature of the cooling unit 74 and the temperature of the cooling plate is set to about 9° C. The residence time of the extruded fruit product within the cooling unit 74 is approximately 4 minutes. The temperature of the extruded fruit product upon exiting the cooling unit 74 is about 18° C.

The start-up steps for this alternative embodiment and the first embodiment are substantially similar.

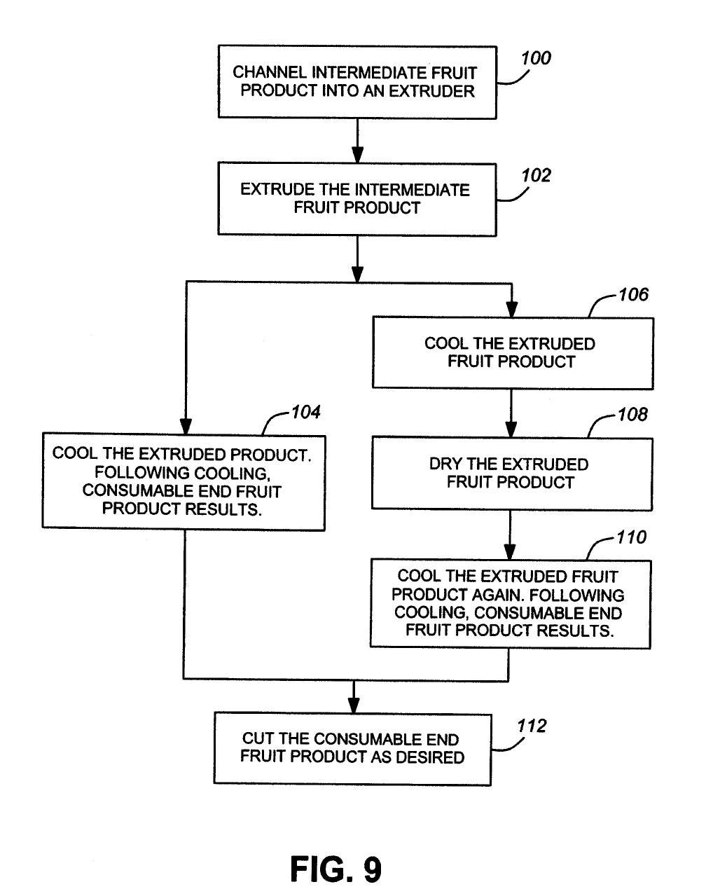

FIG. 9 graphically depicts some of the steps involved in extruding consumable end fruit product, as described above, with respect to the first and second embodiments. Blocks 100 (channeling intermediate fruit product into an extruder), 102 (extruding the intermediate fruit product), and 112 (cutting the consumable end fruit product as desired) are common to both the first and second embodiments. Blocks 106 (cooling the extruded fruit product a first time), 108 (drying the extended fruit product), and 110 (cooling the extruded fruit product a second time) are specific to the second embodiment, while block 104 (cooling the extruded fruit product only a single time) is specific to the first embodiment.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment.

1. A method for producing a consumable end fruit product composed of about 100% fruit from an intermediate fruit product having a sugar content of about 84 to about 88° Brix, the method comprising:
(a) extruding the intermediate fruit product to form an extruded fruit product, wherein the intermediate fruit product is heated to a temperature of at least about 90° C. prior to extrusion; and
(b) cooling the extruded fruit product to about 20° C. to form the consumable end fruit product.

2. (canceled)

3. (canceled)

4. (canceled)

5. (canceled)

6. A method as claimed in claim 1 wherein extruding the intermediate fruit product to form the extruded fruit product comprises:
(a) extruding the intermediate fruit product on to a conveyor belt at an extrusion rate, the extruded fruit product contacting the conveyor belt; and
(b) conveying the extruded fruit product away on the conveyor belt at a belt rate, the extrusion rate being greater than the belt rate, thereby resulting in the extruded fruit product taking on an undulating shape.

7. A method as claimed in claim 6 wherein the ratio of the extrusion rate over the belt rate is about 3.7 kg/m.

8. A method as claimed in claim 6 wherein the ratio of the extrusion rate over the belt rate is at least about 4.0 kg/m.

9. A method as claimed in claim 6 wherein the extrusion rate is about 8.3 kg/min and the belt rate is about 2.1 m/min.

10. A method as claimed in claim 1 wherein cooling the extruded fruit product to form the consumable end fruit product comprises:
(a) cooling the extruded fruit product a first time;
(b) drying the extruded fruit product; and then
(c) cooling the extruded fruit product a second time.

11. A method as claimed in claim 10 wherein cooling the extruded fruit product a first time comprises cooling the extruded fruit product to about 30° C.

12. A method as claimed in claim 10 wherein drying the extruded fruit product comprises heating the extruded fruit product within a drying tunnel having a temperature of about 95° C. for about 20 minutes.

13. A method as claimed in claim 10 wherein cooling the extruded fruit product a second time comprises cooling the extruded fruit product to about 18° C.

14. (canceled)

15. A system for producing a consumable end fruit product composed of about 100% fruit from an intermediate fruit product, the system comprising:
(a) an extruder configured to extrude the intermediate fruit product into an extruded fruit product;
(b) a conveyor positioned to receive the extruded fruit product from the extruder; and
(c) a cooling portion comprising a first cooling unit, the conveyor transporting the extruded fruit product into the cooling portion and the cooling portion outputting the consumable end fruit product.

16. (canceled)

17. (canceled)

18. A system as claimed in claim 15 further comprising:
(a) a drying portion comprising a drying tunnel; and
(b) a second cooling portion comprising a second cooling unit, the extruded fruit product being conveyed from the first cooling portion to the drying portion and then to the second cooling portion, the second cooling portion outputting the consumable end fruit product.

19. (canceled)

20. (canceled)

21. A system as claimed in claim 15 wherein the extruder comprises:
(a) a manifold;
(b) a pump fluidly coupled to the manifold; and
(c) a nozzle fluidly coupled to the pump, the nozzle extruding the intermediate fruit product into the extruded fruit product.

22. A system as claimed in claim 21 wherein steam is circulated through any one or more of the manifold, pump, and nozzle.

23. A system as claimed in claim 21 wherein the nozzle is positioned substantially parallel to and behind a topmost surface of the conveyor belt.

24. A system as claimed in claim 21 wherein the nozzle is positioned above the conveyor belt and a bump is positioned underneath the conveyor belt for receiving the extruded fruit product.

25. A system as claimed in claim 22 wherein steam is circulated in series through a plurality of the pumps such that only the temperature of the last pump in the series needs to be monitored to ensure that the pumps are heated to a temperature suitable for extrusion.

26. A system as claimed in claim 24 wherein the bump has a semi-cylindrical or elliptical shape.

27. A system as claimed in claim 24 wherein the nozzle is positioned at an angle of about 60 degrees relative to the topmost surface of the conveyor belt.

28. A system as claimed in claim 21 wherein the nozzle further comprises a mask having a cross-section of the extruded fruit product.

29. A system as claimed in claim 28 wherein the cross-section has a pattern selected from the group consisting of a rocket ship, a crescent moon, a star, a space ship, a planet, a whale, a sea horse, an octopus, a turtle, or a sea shell, and can also have a pattern such that the extruded fruit product is in the form of a rectangular strip.

30. (canceled)
